(19) United States
(12) Patent Application Publication
(10) Pub. No.: US 2012/0250454 A1
(43) Pub. Date: Oct. 4, 2012

(54) METHOD AND SYSTEM FOR SHAPING A CMUT MEMBRANE

(76) Inventors: Robert Nicholas Rohling, Vancouver (CA); Edmond Cretu, Vancouver (CA); Wei You, Vancouver (CA)

(21) Appl. No.: 13/439,537

(22) Filed: Apr. 4, 2012

Related U.S. Application Data
(60) Provisional application No. 61/471,435, filed on Apr. 4, 2011.

(51) Int. Cl. G03B 42/06; H04B 1/02; B06B 1/06

(52) U.S. Cl. 367/7; 367/140; 367/137; 367/138

(57) ABSTRACT

The present disclosure is directed at a method and system for shaping a membrane a capacitive micromachined ultrasonic transducer, or CMUT. A bias voltage is asymmetrically applied to a membrane of the CMUT such that the membrane is directed to send ultrasonic waves that propagate along a propagation axis that is not parallel with a propagation axis along which ultrasonic waves propagate when the bias voltage is symmetrically applied to the membrane. In this way, the ultrasonic waves that are generated using a CMUT array can be physically steered to or focused on a target. Steering and focusing ultrasonic waves by altering the shape of the membrane by asymmetrically biasing the membrane reduces grating lobes and can also be used as part of an adaptive control system that can improve ultrasound image quality.

This application claims the benefit of U.S. Provisional Patent Application Ser. No. 61/471,435, filed Apr. 4, 2011, which is hereby incorporated by reference in its entirety.

### FIELD OF THE INVENTION

The present disclosure is directed at a method and system for shaping a membrane of a capacitive micromachined ultrasonic transducer (“CMUT”). More particularly, the present disclosure is directed at a method and system for performing ultrasonic imaging by adaptively shaping the CMUT membrane.

### BACKGROUND OF THE INVENTION

Ultrasonic imaging is useful for generating images of a variety of different targets within the human body. It is important that reliable images be acquired especially given ultrasonic imaging's medical uses. Consequently, there exists a continued need to improve the quality and accuracy of ultrasonic imaging.

### SUMMARY OF THE INVENTION

According to a first aspect, there is provided a method for shaping a membrane of a CMUT comprising applying a bias voltage asymmetrically to the membrane such that the membrane is shaped to send ultrasonic waves that propagate along an asymmetrically biased propagation axis that differs from a symmetrically biased propagation axis along which the membrane is shaped to send the ultrasonic waves when the membrane is symmetrically biased.

The method may further comprise generating the ultrasonic waves that propagate along the asymmetrically biased propagation axis by applying a modulation voltage to the membrane. The modulation voltage may be a coded excitation.

The method may further comprise receiving incident ultrasonic waves that propagate along the asymmetrically biased propagation axis.

The membrane may be rotationally symmetric.

Applying the bias voltage may comprise applying a plurality of voltage signals at rotationally symmetric locations on the membrane, wherein at least two of the plurality of voltage signals differ in magnitude. Alternatively, applying the bias voltage may comprise applying a plurality of voltage signals at rotationally asymmetric locations on the membrane, wherein at least two of the plurality of voltage signals have identical magnitudes.

The asymmetrically biased propagation axis and the symmetrically biased propagation axis may intersect at, for example, a location on the membrane or offset from the membrane. Alternatively, the asymmetrically biased propagation axis and the symmetrically biased propagation axis may be parallel, or the asymmetrically biased propagation axis and the symmetrically biased propagation axis may be neither parallel nor intersect.

The symmetrically biased propagation axis may be normal to a substrate of the CMUT when the asymmetrically biased propagation axis is not normal to the substrate of the CMUT.

The bias voltage may comprise an alternating current voltage signal. The alternating current voltage signal may be applied when receiving incident ultrasonic waves.

Applying the bias voltage asymmetrically may comprise applying a first bias voltage across a first pair of electrodes such that the first bias voltage is applied across one lateral half of the membrane, and applying a second bias voltage across a second pair of electrodes such that the second bias voltage is applied across another lateral half of the membrane, wherein the first and second voltages differ in magnitude.

The membrane may be metallized such that applying the bias voltage to the membrane comprises electrically coupling the membrane to a voltage source.

The CMUT may comprise one of a plurality of CMUTs that comprise an array, and each of the plurality of CMUTs may be biased such that propagation axes of the plurality of CMUTs intersect a common focal point. Alternatively, the CMUT may comprise one of a plurality of CMUTs that comprise an array, and each of the plurality of CMUTs may be asymmetrically biased such that the asymmetrically biased propagation axes of the plurality of CMUTs are parallel.

The method may further comprise adaptively shaping the membrane by obtaining a priori information prior to generating the ultrasonic waves, determining the bias voltage in accordance with the a priori information in order to improve an image obtained by analyzing an echo signal that results from reflection of the ultrasonic waves, and generating the ultrasonic waves.

The membrane may also be adaptively shaped by obtaining a priori information prior to generating the ultrasonic waves, determining the modulation voltage in accordance with the a priori information in order to improve an image obtained by analyzing an echo signal that results from reflection of the ultrasonic waves, and generating the ultrasonic waves.

When the membrane is receiving incident ultrasonic waves, the method may also comprise adaptively shaping and vibrating the membrane by obtaining a priori information prior to receiving an echo signal that results from reflection of the ultrasonic waves, wherein the a priori information comprises one or more of frequency, phase and amplitude information current signals that are generated by previously received ultrasonic echoes, determining waveforms of the bias voltage and the modulation voltage from the a priori information, and biasing the membrane using the bias voltage waveform and modulating the membrane using the modulation voltage waveform while receiving the echo signal.

The method may also comprise receiving the echo signal, and generating the image by analyzing the echo signal in accordance with the a priori information. The echo signal may be reflected off an imaging target, and the method may further comprise estimating mechanical properties of the imaging target by analyzing the symmetric and asymmetric parts of the echo signal.

The method may also comprise estimating the direction of arrival of the ultrasonic waves by analyzing the symmetric and asymmetric parts of the echo signal.

According to another aspect, there is provided a system for shaping a membrane of a CMUT. The system comprises the CMUT and a control system communicatively coupled to the CMUT that comprises a controller and a memory communicatively coupled to the controller having encoded thereon statements and instructions to cause the control system to execute a method as described above.

The control system may also comprise a beamformer configured to output beamforming parameters comprising a bias voltage corresponding to a direction in which the CMUT is to transmit ultrasonic waves, and a processing unit communicatively coupled between the beamformer and the CMUT containing the controller and the memory.

According to another aspect, there is provided a computer readable medium having encoded thereon statements and instructions to cause a processor to execute a method as described above.

This summary does not necessarily describe the entire scope of all aspects.

Other aspects, features and advantages will be apparent to those of ordinary skill in the art upon review of the following description of specific embodiments.

### BRIEF DESCRIPTION OF THE DRAWINGS

In the accompanying drawings, which illustrate one or more exemplary embodiments:

FIG. 1 is a schematic view of an ultrasound imaging probe directing ultrasonic waves at a target.

FIGS. 2 and 3 are sectional views of a CMUT having an asymmetrically shaped membrane, according to one embodiment.

FIG. 4 is a block diagram of a control system for shaping the membrane of the CMUT, according to another embodiment.

FIG. 5 is a schematic view of the CMUT having three pairs of electrodes that can apply a bias and a modulation voltage to the membrane of the CMUT, according to another embodiment.

FIGS. 6(a) to (c) are schematic views of various embodiments of the CMUT having differently shaped electrode pairs.

FIGS. 7(a) and (b) are schematic views depicting various embodiments that can be used to steer ultrasonic waves emitted by the CMUT and by an array composed of multiple CMUTs.

FIG. 8 is a block diagram of the control system of FIG. 4 being used to shape the membranes of the array of CMUTs.

FIGS. 9(a) to (d) are schematic views depicting various embodiments that can be used to steer and focus ultrasonic waves emitted by one and two dimensional arrays of CMUTs.

FIGS. 10 and 11 are schematic views showing embodiments of one-dimensional arrays of CMUTs being used to steer and focus ultrasonic beams.

FIGS. 12 and 13 are graphs of beam profile in dB vs. directivity in degrees, comparing conventional electronic focusing and steering to physical focusing and steering performed according to another embodiment.

FIG. 14 is a schematic view of a phantom with which arrays of CMUTs were tested.

FIGS. 15 to 18 are images of the phantom of FIG. 14 generated by arrays of CMUTs using both electronic and physical focusing and steering, according to another embodiment.

FIG. 19 is a finite element model of the CMUT, according to another embodiment.

FIGS. 20 to 23 are various graphs illustrating how the finite element model of the CMUT of FIG. 19 can be used to predict movement of the CMUT and directions of the directed ultrasonic waves.

### DETAILED DESCRIPTION OF THE INVENTION

Directional terms such as “top”, “bottom”, “left”, “right”, “horizontal”, “vertical”, “transverse” and “longitudinal” are used in this description merely to assist the reader to understand the described embodiments and are not to be construed to limit the orientation of any described method, product, apparatus or parts thereof, whether in operation or in connection to another object.

A capacitive micromachined ultrasonic transducer (“CMUT”) is an ultrasonic transducer that includes a membrane that is suspended over a conductive silicon substrate by insulating posts. By applying an alternating voltage signal across the membrane, the membrane can be caused to vibrate and consequently to generate ultrasonic waves; similarly, when the membrane is stimulated by ultrasonic waves that are incident on the membrane, the membrane generates a signal indicative of the strength of the incident ultrasonic waves. As a result of these characteristics, CMUTs can be used in the manufacture of ultrasound imaging probes. In the context of an ultrasound imaging probe, each individual CMUT used on the probe is referred to as a “CMUT cell”; to increase signal strength, multiple CMUT cells are grouped together and form a “CMUT element”; and multiple CMUT elements grouped together are referred to as a “CMUT array”. The CMUT cells that form one of the CMUT elements may all be identically controlled using identical control signals or alternatively may be independently controlled using potentially different control signals.

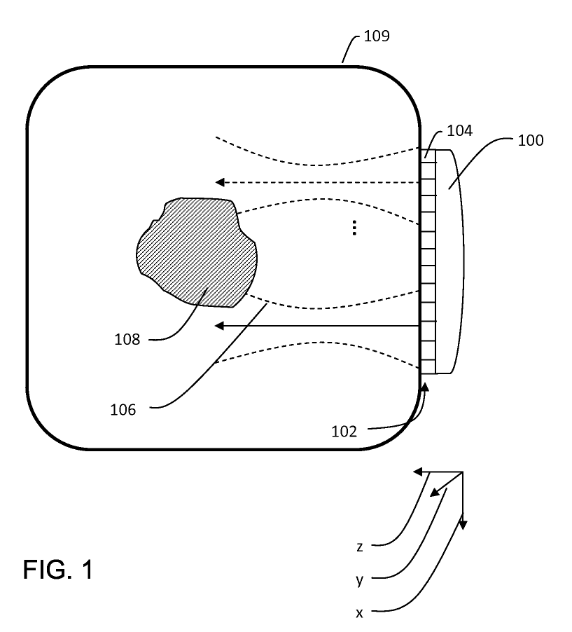

Referring now to FIG. 1, there is shown a sectional view of an ultrasound imaging probe 100 that has on one side of it a CMUT array 102 that is composed of a linear arrangement of CMUT elements 104. Each of the CMUT elements 104 is electrically stimulated, and consequently each of the CMUT elements 104 emits an ultrasonic wave 106. Typically, various groups of the CMUT elements 104 are each configured to emit a group of the ultrasonic waves 106, with each group of the ultrasonic waves 106 directed at a particular target 108 (e.g.: a cyst) in a medium 109 (e.g.: human tissue); the curved, dashed lines in FIG. 1 represent any one of the groups of ultrasonic waves 106. Collectively, the ultrasonic waves 106 emitted by the CMUT array 102 are called an “ultrasonic beam”. When the CMUT array 102 is placed against human skin, the ultrasonic beam propagates through the medium 109, reflects off boundaries of different tissue types, and is partially reflected back to the CMUT array 102. A beamformer and signal processing and conditioning circuitry (not shown) communicatively coupled to the CMUT array 102 can measure the signals that the CMUT elements 104 in the CMUT array 102 generate in response to multiple reflections of the ultrasonic beam (“echo signal”), and from the timing and amplitude of the reflections can generate an image. The process of generating the ultrasonic beam is called “transmit beamforming”; similarly, the process of processing the echo signal into signals that are subsequently used to generate an image is called “receive beamforming”.

In FIG. 1, the ultrasonic waves 106 propagate in an axial direction (“z-axis”) following emission, which is perpendicular to a lateral direction (“x-axis”) along which the CMUT array 102 extends. The axial and lateral directions are both perpendicular to an elevational direction (“y-axis”). In FIG. 1, a constant bias voltage and an alternating modulation voltage are applied to the membranes of each of the CMUT cells (not shown) of the CMUT array 102. The bias voltage adjusts the sensitivity of the CMUT cells, while the modulation voltage causes the membranes to vibrate and to generate the ultrasonic waves 106. Conventionally, both the modulation and bias voltages are applied symmetrically across the membranes of each of the CMUT cells. In the context of FIG. 1, “symmetrically” refers to “bilateral symmetry”; i.e., when any of the membranes in the CMUT array 102 is bisected along the yz plane into two halves, the modulation voltage and the bias voltage applied to one of the halves are a reflection, in the yz plane, of the modulation voltage and the bias voltage applied to the other of the halves.

The surface of the CMUT elements 104 from which the ultrasonic waves 106 are emitted is normal to the z-axis. The ultrasonic waves 106 emitted from different CMUT elements 104 are combined such that they meet at a certain focal point in the medium 109 that is to be scanned, or such that they are parallel with each other but non-parallel with the z-axis. The process of concentrating ultrasonic energy at the focal point is called “focusing”; the process of concentrating ultrasonic energy along axes that are parallel to each other but not parallel with the z-axis is called “steering”. Conventionally, steering and focusing are accomplished using wave interference. The CMUT elements 104 emit the ultrasonic waves 106 at different times and amplitudes (“interference parameters”) such that the emitted ultrasonic waves 106 interfere with each other to create an adequately steered or focused ultrasonic beam. The resulting echo signal is processed in accordance with the interference parameters to generate the image. Accomplishing focusing and steering relying on wave interference is known as “electronic focusing” and “electronic steering”, respectively.

Relying on electronic steering and focusing can be problematic. For example, in the CMUT array 102 depicted in FIG. 1, the majority of the energy emitted by the CMUT array 102 propagates along the z-axis. Consequently, utilizing wave interference to focus and steer the ultrasonic beam is a relatively inefficient use of energy, as wave interference relies on relatively low energy components of ultrasonic energy that propagate along the x and y-axes. Related to the fact that the majority of the emitted ultrasonic energy is concentrated along the z-axis is the problem that it can be difficult to focus and steer the ultrasonic beam in a direction that is relatively far from normal to the surface of the CMUT array 102. Yet another problem associated with using wave interference is generation of imaging artefacts such as grating lobes. When the ultrasonic beam is focused and steered, the majority of the energy of the ultrasonic beam is contained within a “main lobe”. Grating lobes are reduced amplitude copies of the main lobe that create false images of the target 108. Conventionally, the effect of grating lobes is reduced by controlling the size of the gaps between neighbouring CMUT elements 104 along the CMUT array 102; however, this is problematic in that as the size of the gaps is adjusted to reduce the effect of the grating lobes, the main lobe broadens and the CMUT array 102 may become less suitable for high frequency applications.

The embodiments described herein are directed at a CMUT that has a membrane that, when vibrated, generates ultrasonic waves. In lieu of relying on wave interference to steer and focus the ultrasonic waves, the shape of the CMUT membrane can be altered by asymmetrically applying various bias voltages across it. By altering the shape of the CMUT membrane in this way, the angle at which the CMUT emits the ultrasonic waves can be controlled. Consequently, steering and focusing can be performed by directing the ultrasonic waves directly at a target, instead of by relying on wave interference; performing steering and focusing by altering the shape of the membrane 202 is hereinafter referred to as “physical steering” and “physical focusing”, respectively. This results in a more efficient use of ultrasonic energy, allows the ultrasonic waves to be efficiently directed at a wide range of angles, and reduces problems associated with grating lobes.

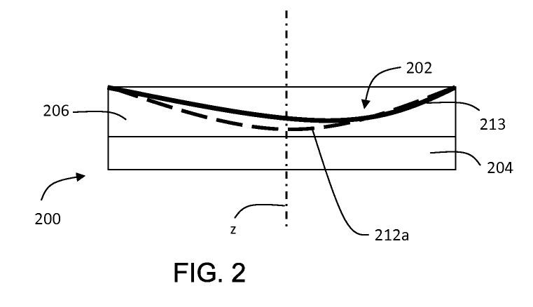

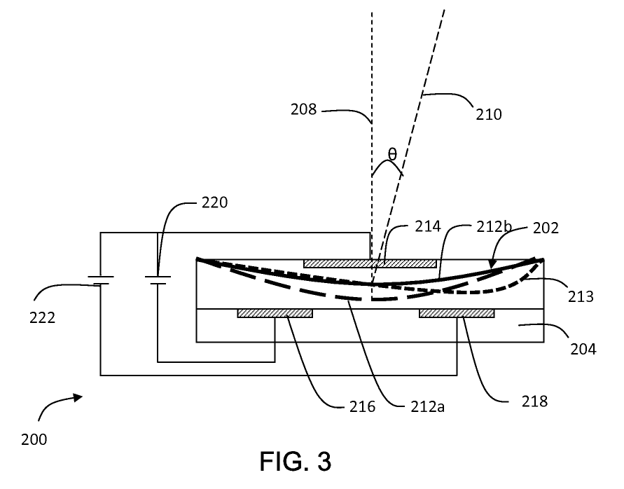

Referring now to FIG. 2, there is shown a sectional view of one of the CMUT cells 200, hereinafter referred to simply as a CMUT 200, according to one embodiment. The z-axis is also shown in FIG. 2 for ease of reference. The CMUT 200 includes the substrate 204 above which is affixed the membrane 202. In FIG. 2, the membrane 202 is shown as being in two different positions. The membrane 202 shown in a dashed line is in a first symmetrically biased position 212a, where the membrane 202 shown in a solid line is in an asymmetrically biased position 213. The bias voltage is symmetrically applied to the membrane 202 in order to deform the membrane 202 to the first symmetrically biased position 212a, whereas the bias voltage is asymmetrically applied to the membrane 202 to deform it to the asymmetrically biased position 213. As discussed in more detail below in respect of FIG. 3, the membrane 202 in the asymmetrically biased position 213 is deformed such that the ultrasonic waves 106 it emits propagate in a different direction than the ultrasonic waves 106 emitted from the membrane 202 in the first symmetrically biased position 212a. Alternatively, the membrane 202 in the asymmetrically biased position 213 may be asymmetrically deformed as a result of receiving asymmetrically incident echo signals, and not because of any asymmetrically applied bias voltage. Between the membrane 202 and the substrate 204 is a vacuum gap 206; in an alternative embodiment, an air gap may instead be located between the membrane 202 and the substrate 204. Also as discussed in more detail below, the modulation voltage can be applied across the membrane 202, which causes the membrane 202 to vibrate and to generate the ultrasonic waves 106.

Referring now to FIG. 3, the CMUT 200 is shown having various electrodes disposed on it across which can be applied voltages that shape the membrane 202 and that cause the membrane to generate the ultrasonic waves 106. The CMUT 200 shown in FIG. 3 has a left bottom electrode 216 disposed on the left side of the substrate 204, a right bottom electrode 218 disposed on the right side of the substrate 204, and a top electrode 214 disposed above the bottom electrodes 216, 218 such that the modulation and bias voltages can be applied to the membrane 202. The left and right bottom electrodes 216, 218 can be located within the substrate 24, while the top electrode 214 can be located, for example, above the membrane 202, within the membrane 202, or the membrane 202 itself can act as an electrode when the membrane 202 is metallized. Electrically coupled across the left bottom electrode 216 and the top electrode 214 is a first voltage source 220, while electrically coupled across the right bottom electrode 218 and the top electrode 214 is a second voltage source 222. Each of the first and second voltage sources 220, 222 can be composed of superimposed direct-current (“DC”) and alternating-current (“AC”) components. The DC components act as the bias voltage across the membrane 202 that alters the unbiased shape of the membrane 202. The AC components act as a modulation voltage across the membrane 202 that causes the membrane 202 to vibrate and consequently to generate the ultrasonic waves 106.

In FIG. 3, when the modulation voltage is applied to the membrane 202 and the bias voltage is symmetrically applied to the membrane 202 (i.e.: the bias voltage between the top electrode 214 and the left bottom electrode 216 equals the bias voltage between the top electrode 214 and the right bottom electrode 218), the resulting ultrasonic waves 106 propagate along a symmetrically biased propagation axis 208 that passes through the centre of the membrane 202; as the membrane 202 is symmetrically disposed on the substrate 204, the symmetrically biased propagation axis 208 is normal to the substrate 204. In one embodiment, the symmetrically biased propagation axis 208 is more generally defined as the propagation axis along which the ultrasonic waves propagate when the entire membrane 202 is uniformly biased at the same bias voltage (e.g.: when the membrane 202 is unbiased at 0 V or uniformly biased at 50 V). In FIG. 3, the membrane 202 is shown in two positions in which the bias voltage is symmetrically applied, and in which emitted ultrasonic waves 106 propagate along the symmetrically biased propagation axis 208: the first symmetrically biased position 212a and a second symmetrically biased position 212b. The bias voltage applied to the membrane 202 to deform it to the first symmetrically biased position 212a is greater than the bias voltage applied when the membrane 202 is in the second symmetrically biased position. The size of the vacuum gap 206 when the membrane 202 is in the first symmetrically biased position 212a is smaller than when the membrane 202 is in the second symmetrically biased position 212b; this helps increase the sensitivity of the membrane 202 to the echo signal, and in particular to the echo signal that is incident along the symmetrically biased propagation axis 208. When the DC component applied by the second voltage signal 222 is greater than that applied by the first voltage signal 220 the membrane 202 moves into an asymmetrically biased position 213. The asymmetrically biased position 213 is laterally asymmetrical with respect to the substrate 204, and the ultrasonic waves 106 emitted from the membrane 102 when in the asymmetrically biased position 213 propagate along an asymmetrically biased propagation axis 210 that is directed at a steering angle (θ) relative to the symmetrically biased propagation axis 208. When in the asymmetrically biased position 213, the membrane 202 is also particularly sensitive to receiving echo signals along the asymmetrically biased propagation axis 210.

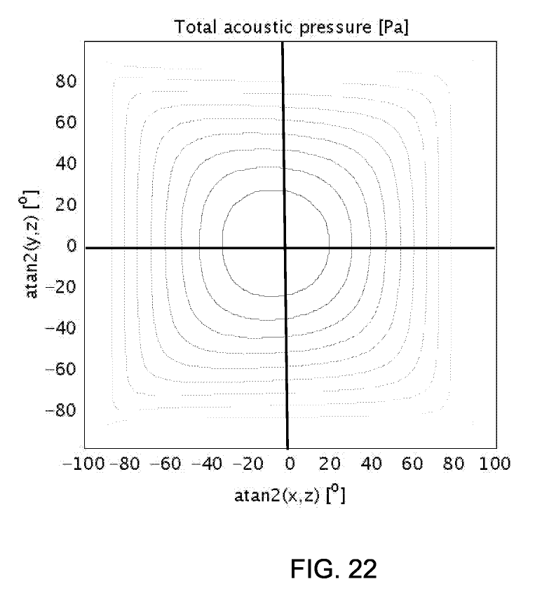

In the depicted embodiment, the symmetrically biased propagation axis 208 and the asymmetrically biased propagation axis 210 are considered to extend along the centre of the region of highest acoustic pressure of the ultrasonic waves 106 (see, e.g., the centre of the darkest region of FIG. 22, as discussed in more detail below). However, in alternative embodiments the axes 208, 210 may be considered to extend along different regions of the ultrasonic waves 106. In order to facilitate easy comparison between the axes 208, 210, the paths along which the symmetrically biased propagation axis 208 and the asymmetrically biased propagation axis 210 extend can be determined in similar or identical fashions.

Also in the depicted embodiment, the asymmetrically biased propagation axis 210 intersects the symmetrically biased propagation axis 208 at the surface of the membrane 202; however, in alternative embodiments (not depicted), intersection between the axes 208, 210 may occur offset from (i.e.: above or below) the membrane 202. In another alternative embodiment (not depicted), the asymmetrically biased propagation axis 210 and the symmetrically biased propagation axis 208 may not intersect at all, as the asymmetrically applied bias voltage may result in only a lateral shifting of the symmetrically biased propagation axis 208 such that the axes 208, 210 are parallel to each other.

In the embodiment of FIG. 3, one top electrode and two bottom electrodes, equally spaced from the edges of the CMUT 200, are shown. In alternative embodiments (not depicted), multiple top electrodes may be used. Additionally or in the alternative, one or three or more bottom electrodes may be used. When multiple electrodes are used, they may or may not be spaced equally from the edges of the CMUT 200, and may or may not be spaced equally from each other. Even when multiple top electrodes are used, the membrane 202 may be metallized such that the membrane 202 itself acts as a conduction element. Furthermore, the symmetrically biased propagation axis 208 need not be normal to the substrate 204; for example, the membrane 202 may be manufactured asymmetrically such that even when the membrane 202 is symmetrically biased, the symmetrically biased propagation axis 208 is not parallel to the normal of the substrate 204.

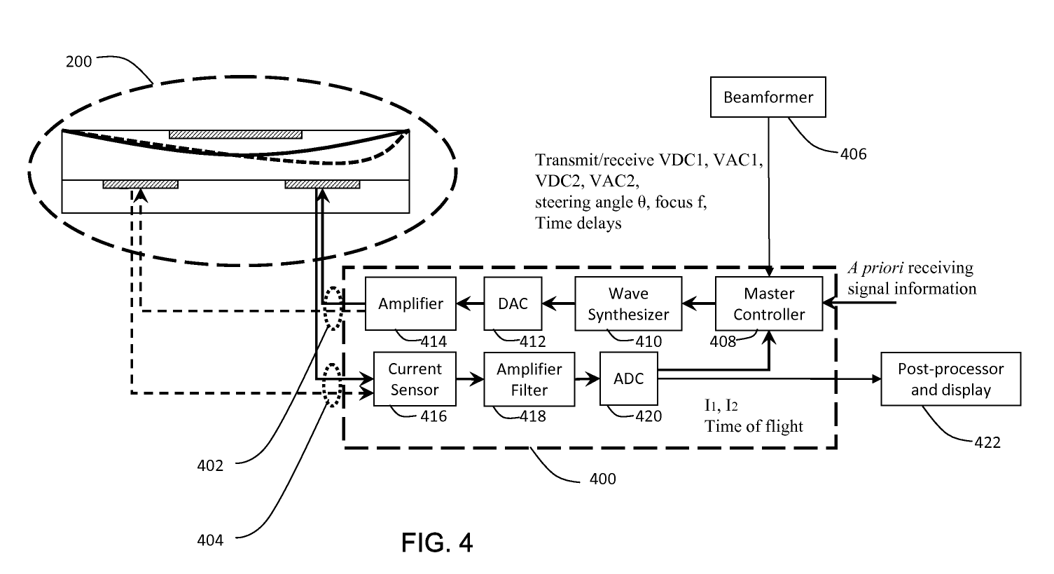

Referring now to FIG. 4, there is shown a control system composed of an adaptive processing unit 400 communicatively coupled between a beamformer 406 and the CMUT 200. The beamformer 406 sends beamforming parameters to the processing unit 400 that is used to generate control signals 402 sent to the CMUT 200 to generate the ultrasonic waves 106 and to process current signals 404 received from the CMUT 200 as a result of the echo signal. The beamforming parameters include the magnitude of the bias and modulation voltages; the steering angle θ; a focal distance f, which is a distance from the CMUT 200 at which multiple ultrasonic waves 106 intersect, and time delays that can be used for electronic steering and focusing. The focal distance f for the CMUT array 104 is measured as the distance between the target 108 and the centre of the CMUT array 104. In FIG. 4, the component of the bias voltage that is applied between the top electrode 214 and the left bottom electrode 216 is referred to as V_{DC1}; the component of the bias voltage that is applied between the top electrode 214 and the right bottom electrode 218 is referred to as V_{DC2}; the component of the modulation voltage that is applied between the top electrode 214 and the left bottom electrode 216 is referred to as V_{AC1}; and the component of the modulation voltage that is applied between the top electrode 214 and the right bottom electrode 218 is referred to as V_{AC2}.

A master controller 408 within the processing unit 400 receives the beamforming parameters and conveys them to a wave synthesizer 410 that uses them to generate digital control signals that form the basis of the control signals 402 that are applied to the CMUT 200. The digital control signals are conveyed to and converted into analog form by a digital-to-analog converter (“DAC”) 412. The output of the DAC 412 is amplified by an amplifier 414, and the amplifier 414 outputs the control signals 402 that are fed to the CMUT 200 and that result in generation of the ultrasonic waves 106 that are one or both of steered and focussed in accordance with the steering angle θ and focal distance f.

After receiving the echo signals, the CMUT 200 generates the current signals 404 and sends them to the processing unit 400. The top electrode 214 and the left bottom electrode 216, and the top electrode 214 and the right bottom electrode 218 each generate one of the current signals 404. A current sensor 416 within the processing unit 400 receives the current signals 404 and converts them into voltage signals that are output to an amplifier and filter 418 that amplifies and filters the voltage signals. The amplified and filtered voltage signals are sent to and digitized by an analog-to-digital converter (“ADC”) 420, and are then sent to a post-processor and display 422 where the image of the target 108 can be constructed. The master controller 408 also receives the digitized signals from the ADC 420 in order to extract a priori receiving information from them, as discussed in more detail below. The post-processor and display 422 utilize the time of flight of the ultrasonic waves 106 and the magnitude of the echo signals in constructing the image.

As indicated in FIG. 4, the master controller 408 can utilize a priori receiving signal information (“a priori information”) to better focus and steer the ultrasonic waves 106. For any given one of the ultrasonic waves 106, “a priori information” refers to information obtained prior to generation of the ultrasonic wave 106 that can be used to influence generation of the ultrasonic wave 106 or receipt of the echo signals so as to obtain a more accurate image of the target 108 than would be obtained without using the a priori information. A priori information may be, for example, information relating to the location and composition of the target 108, composition of the medium 109, and phase and amplitude of previous echo signals. Based on the location of the target 108, for example, the master controller 408 may conclude that a stronger ultrasonic wave 108 should be generated in order to ensure that the target 108 is bombarded with enough ultrasonic energy to result in echo signals that are sufficient for image construction. Alternatively, the master controller 408 may alter the steering angle θ or focal distance f using knowledge relating to the location of the target 108 to ensure more of the ultrasonic waves 106 are directed at the target 108. As another example, when the a priori information indicates the time of flight is going to be relatively long, the master controller 408 may increase the sensitivity of the CMUT 200 by increasing the bias voltage such that the vacuum gap 206 is decreased in order to compensate for signal attenuation. Additionally or alternatively, the a priori information may be that the tissue through which the ultrasonic waves 106 propagate cause aberrations in the ultrasonic waves 106; in this case, the master controller 408 may shape the membrane 202 to correct for such aberrations. As another example, the a priori information may be that the ultrasonic waves 106 will be propagating through both fat and muscle tissue at different velocities to and from the target 108, and that the master controller 408 should take these different velocities into account in order to accurately determine the location of the target 108.

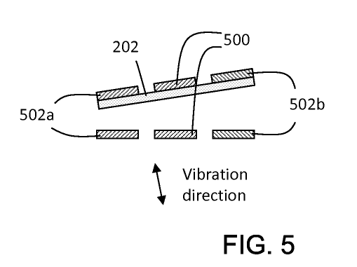

Referring now to FIG. 5, there is shown a schematic, sectional view of one embodiment of the CMUT 200. In the embodiment of FIG. 5, and in contrast to the embodiment of the CMUT 200 shown in FIG. 3, three different pairs of electrodes are used to apply voltages to the membrane 202. A pair of actuating electrodes 500 are disposed centrally on the membrane 202 and the substrate 204 across which the modulation voltage is applied. Two pairs of bias electrodes, a pair of left bias electrodes 502a and a pair of right bias electrodes 502b, are used to shape the membrane 202 such that the asymmetrically biased propagation axis 210 is either pointed to the left or to the right; in FIG. 5, the bias voltage across the pair of left bias electrodes 502a is greater than the bias voltage across the pair of right bias electrodes 502b, and the membrane 202 consequently tilts to the left. In an alternative embodiment (not shown), the pair of actuating electrodes 500 can be removed, and the bias electrodes 502a, 502b can be used to apply both the modulation and bias voltages.

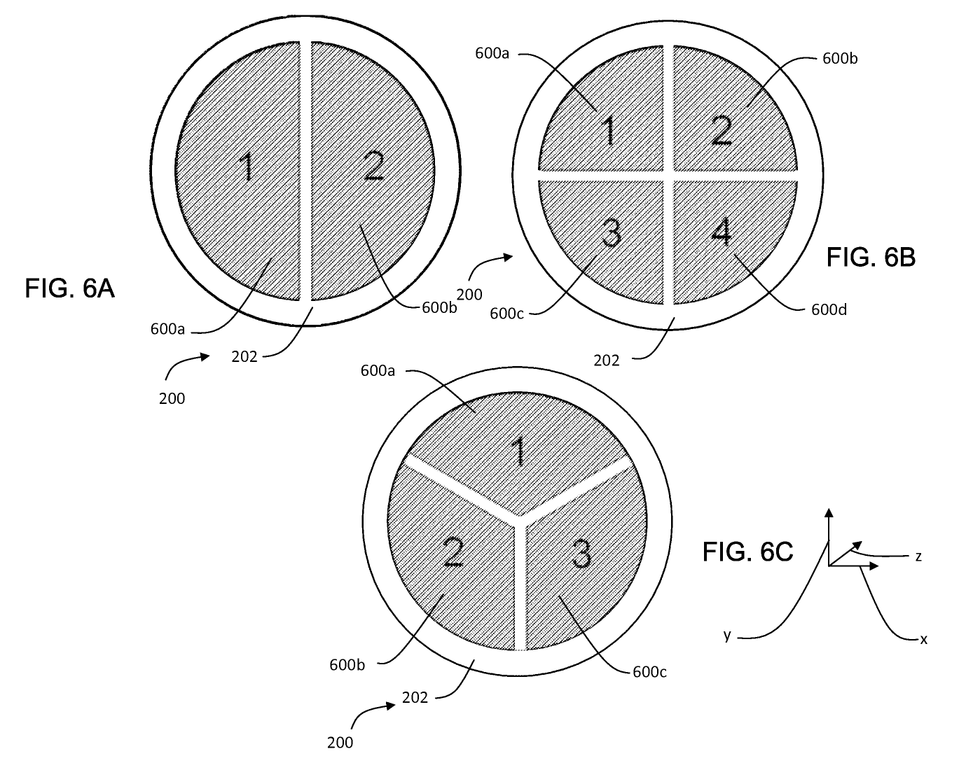

Referring now to FIGS. 6(a)-(c), there are depicted top plan views of different embodiments of the CMUT 200, with each of the depicted embodiments showing different layouts of electrode pairs 600a-d. Only the top electrode of each of the electrode pairs 600a-d is shown in FIGS. 6(a)-(c). The bottom electrodes are correspondingly arranged.

In FIG. 6(a), each of the first and second electrode pairs 600a, b are semicircular in shape and have identical areas. The electrode pairs 600a, b are positioned such that the membrane 202 can be tilted about the y-axis. In FIG. 6(b), the first through fourth electrode pairs 600a-d are used. Each of the electrode pairs 600a-d are equal in area and shaped as a quarter circle. When the bias voltage applied across the first and second electrode pairs 600a, b differs from the bias voltage applied across the third and fourth electrode pairs 600c, d, the membrane 202 tilts about the x-axis. When the bias voltage applied across the first and third electrode pairs 600a, c differs from the bias voltage applied across the second and fourth electrode pairs 600b, d, the membrane 202 tilts about the y-axis. Other combinations are also possible. For example, the asymmetric bias voltage may be applied solely to one of the four electrode pairs 600a-d. In FIG. 6(c), the first through third electrode pairs 600a-c are equal in area and shaped as a third of a circle. Applying a bias voltage to any one or two of the electrode pairs 600a-c tilts the membrane 202 about both the x and y-axes.

In FIGS. 6(a)-(c), the electrode pairs 600a-d are located in a rotationally symmetric arrangement relative to the membrane 202. Consequently, the electrode pairs 600a-d can be used to apply the bias voltage to rotationally symmetric locations on the membrane 202. When the bias voltage is applied to rotationally symmetric locations on the membrane 202 and the same voltage is applied to each of these locations, the membrane 202 is symmetrically biased. Similarly, when different voltages are applied to each of these locations, the membrane 202 is asymmetrically biased. The membrane 202 may also be symmetrically biased when the bias voltage is applied to rotationally asymmetric locations on the membrane 202 but at different magnitudes such that the net force on the membrane 202 nonetheless shapes the membrane 202 such that any emitted ultrasonic waves propagate along the symmetrically biased propagation axis 208 of the membrane 202. Similarly, the membrane 202 may be asymmetrically biased when the bias voltage is applied to rotationally symmetric locations on the membrane 202, but at different magnitudes to all locations. Although the membranes 202 shown in FIGS. 6(a)-(c) are circular, in alternative embodiments (not depicted) different membrane shapes are possible. Rotationally symmetric membranes such as regular polygons may be used; alternatively, asymmetric membranes that are amorphously shaped or shaped as irregular polygons may be employed.

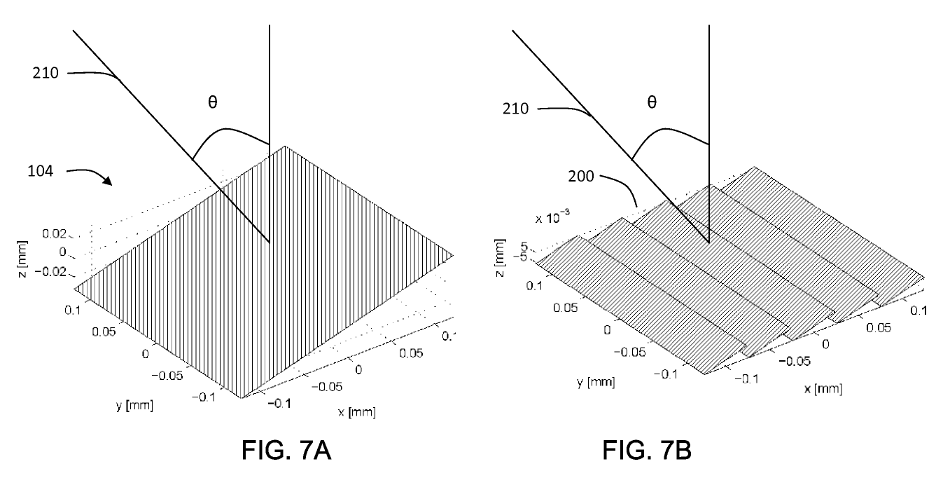

Referring now to FIG. 7(b), there is shown an array of five CMUTs 200. Each of the five CMUTs 200 is tilted at a steering angle θ through asymmetric application of a bias voltage, as discussed above. Consequently, the ultrasonic waves 106 generated by the CMUTs 200 are directed along the asymmetrically biased propagation axis 210 of each of the CMUTs 200; for ease of illustration, only one of the asymmetrically biased propagation axes 210 is depicted in FIG. 7(b). This has empirically been found to provide a similar steering effect as steering at the steering angle θ one of the CMUT elements 102 that is composed of the five CMUTs 200, which is depicted in FIG. 7(a).

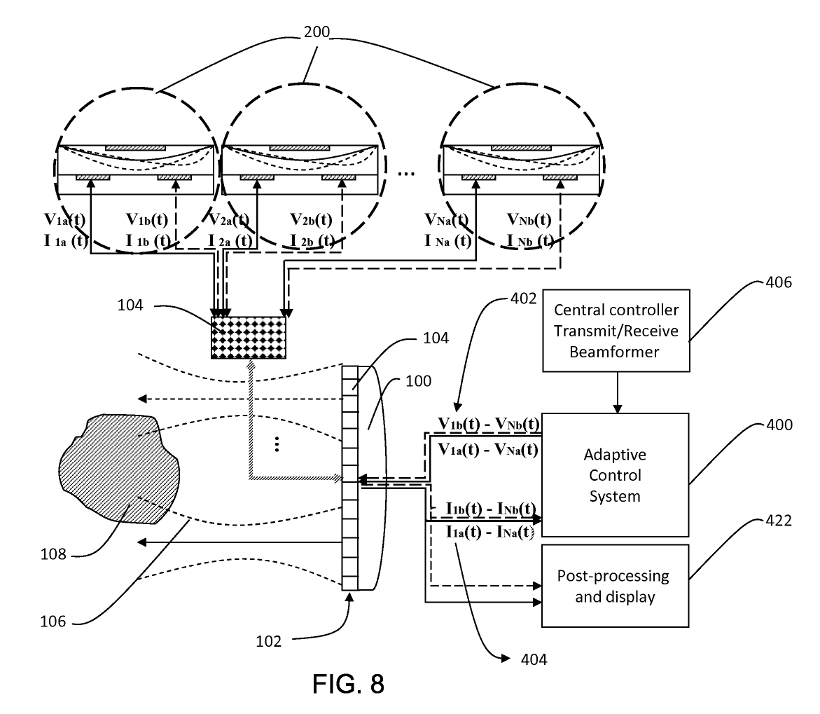

Referring now to FIG. 8, there is shown the adaptive processing unit 400 communicatively coupled to the CMUT array 102. As described with respect to FIG. 4, the beamformer 406 sends the beamforming parameters to the adaptive processing unit 400, which in turn uses them to generate the control signals 402 that are used by the CMUTs 200 to generate the ultrasonic waves 106. In the embodiment of FIG. 8, groups of the individual CMUTs 200 form the CMUT elements 104, which collectively form the CMUT array 102. Each of the individual CMUTs 200 in the depicted embodiment has three electrodes: the top electrode 214, the left bottom electrode 216, and the right bottom electrode 218. The CMUT array 102 of FIG. 8 has a total of N individual CMUTs 200, with one of the control signals 402 resulting in a voltage across the top electrode 214 and the left bottom electrode 216 (V_{Na(t)}) and another of the control signals 402 resulting in a voltage across the top electrode 214 and the right bottom electrode 218 (V_{Nb(t)}). The current signals 404 generated by the echo signals are analogously labelled I_{Na(t)} and I_{Nb(t)}. As discussed above in respect of FIG. 4, the current signals 404 are sent to the processing unit 400 so that a priori information can be extracted and sent to the post-processor and display 422 for image reconstruction.

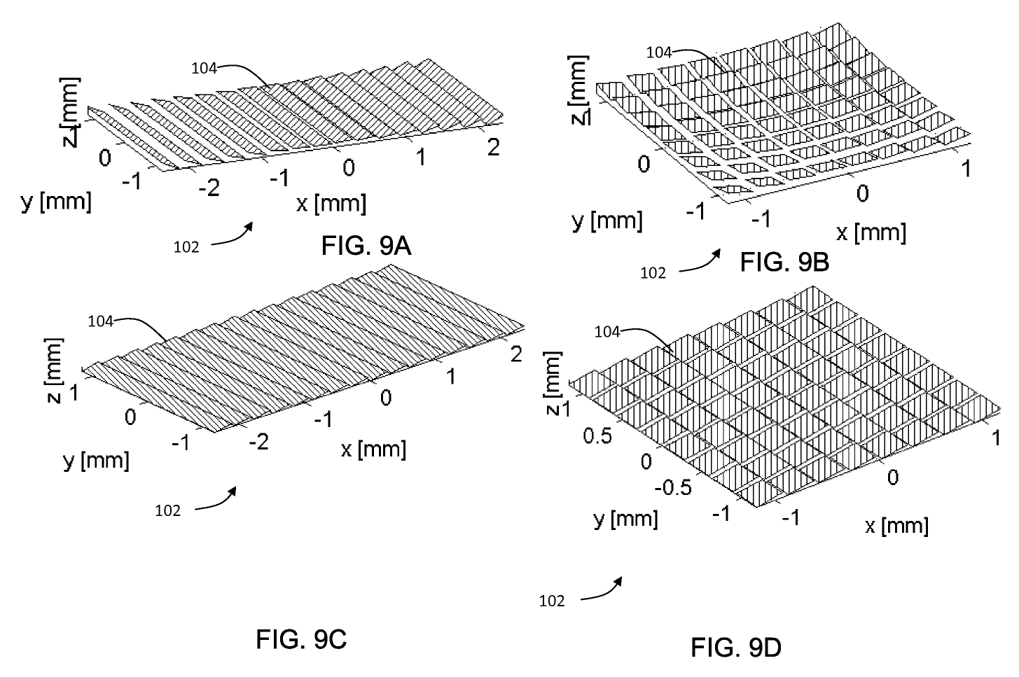

Referring now to FIGS. 9(a)-(d), there are shown various ways in which one and two dimensional CMUT arrays 102 composed of multiple CMUT elements 104 can be physically steered and focussed. In FIG. 9(a), the CMUT array 102 is a one-dimensional 1×16 array composed of sixteen of the CMUT elements 104, and the target 108 for the array 102 is located a focal distance f above the centre of the array 102. In FIG. 9(b), the CMUT array 102 is a two-dimensional 8×8 array composed of sixty-four of the CMUT elements 104, and the target 108 for the array 102 is located a focal distance f above the centre of the array 102. For both the 1×16 and 8×8 arrays, the symmetrically biased propagation axis 208 for each of the CMUT elements 104 is normal to the substrate 204. The steering angle θ for any particular one of the CMUT elements 104 equals tan⁻¹(d/f), where f is the focal distance and d is the distance between the centre of the array 102 and the centre of the particular CMUT element 104 being focused. In FIGS. 9(c) and 9(d), the 1×16 CMUT array 102 and the 8×8 CMUT array 102 are both steered at a particular steering angle; i.e., each of the individual CMUT elements 104 is steered at the particular steering angle.

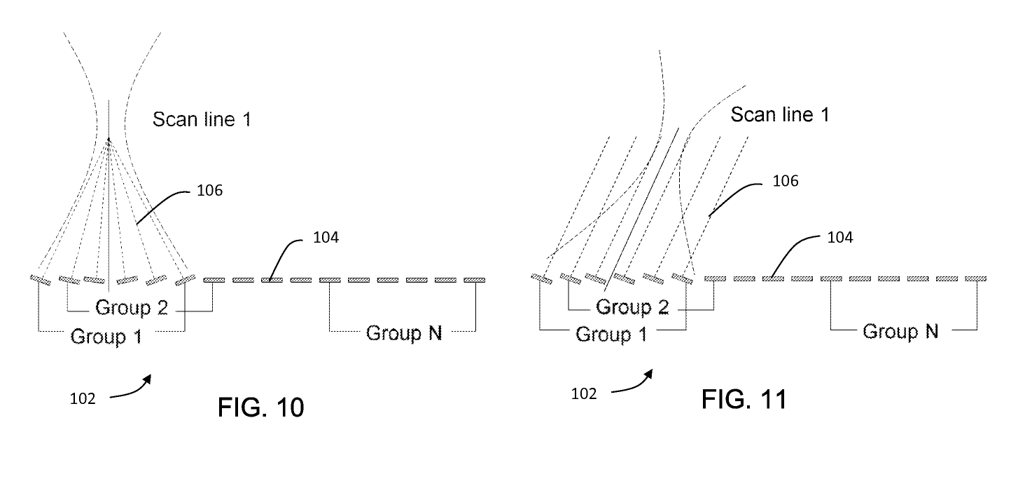

Referring now to FIGS. 10 and 11, there is shown a schematic, side elevation view of the linear 1×16 CMUT array 102. The CMUT array 102 is divided into eleven groups; each group is composed of six adjacent CMUT elements 104 in series. In FIG. 10, group 1 is configured to focus at a single focal point, while in FIG. 11 group 1 is directed at the steering angle θ. The ultrasonic waves 106 emitted by each of the CMUT elements 104 in the array 102 collectively form the ultrasonic beam. For both of the arrays 102 shown in FIGS. 10 and 11, during typical operation, groups 1 through 11 are fired sequentially; e.g.: group 1 is fired at the target 108, then group 2 is fired at the target, etc., until group 11 is fired at the target 108. By directing the ultrasonic waves 106 towards the focal point for each of the groups, the effective spacing between and effective area of the CMUT elements 104 in the CMUT array 102 is altered such that the constructive interference between the ultrasonic waves 106 emitted from different CMUT elements 104, which results in the grating lobes, is mitigated, thereby also mitigating the intensity of the grating lobes. The focal point used for each of the groups may or may not be identical. When the focal point used for each of the groups is not identical, each subsequent group may have a focal point adjacent to that of the previous group (e.g.: in FIG. 10, the focal point for Group n may be to the right of that of Group n−1). Consequently, each of the groups can obtain measurements taken along a different scan line, and the measurements obtained along the various scan lines can be combined together into a single image.

In addition to focusing and steering the ultrasonic waves 106 by shaping the membranes 202 of the CMUTs 200 that form the CMUT elements 104, electronic focusing and steering can also be performed. For example, in FIG. 10, group 1 may perform physical focusing, while any one or more of groups 2 through 11 perform electronic focusing. Alternatively, any one or more of groups 2 through 11 may be physically or electronically focussed at a different target, or be physically or electronically steered. The CMUT array 102 shown in FIG. 11 is similarly customizable. While FIGS. 10 and 11 illustrate physical focusing and steering being done separately, this is done for clarity only and in practice physical focusing and steering can be performed using the same groups of elements during any given transmit cycle of the ultrasonic beam (e.g.: as groups 1 to 11 fire, any number of the groups may be performing physical focusing while the remainder of the groups may be performing physical steering). Although FIGS. 10 and 11 depict linear arrays, the multi-dimensional arrays depicted in FIGS. 9(b) and (d) can also be divided into groups and analogously used. In particular, physical focusing a two-dimensional array as depicted in FIG. 9(b) can facilitate 3D imaging. Beneficially, by performing physical focusing, less powerful or no focusing lenses can be employed relative to the focusing lenses typically used when focusing is done electronically. This can result in ultrasound measurements that have a relatively high signal-to-noise ratio. In addition, the element spacing of conventional ultrasound transducer arrays is fixed and designed to minimize the grating lobes up to a certain frequency, such as the resonant frequency of the transducer array. This fixed spacing may produce artefacts in higher frequency, wide band applications. In contrast, the CMUT array 102 allows the orientations of the individual CMUT elements 104 to be adaptively changed such that the grating lobes can be reduced for multiple frequencies selected from a broader frequency band than when using conventional ultrasound transducer arrays.

### EXPERIMENTAL DATA

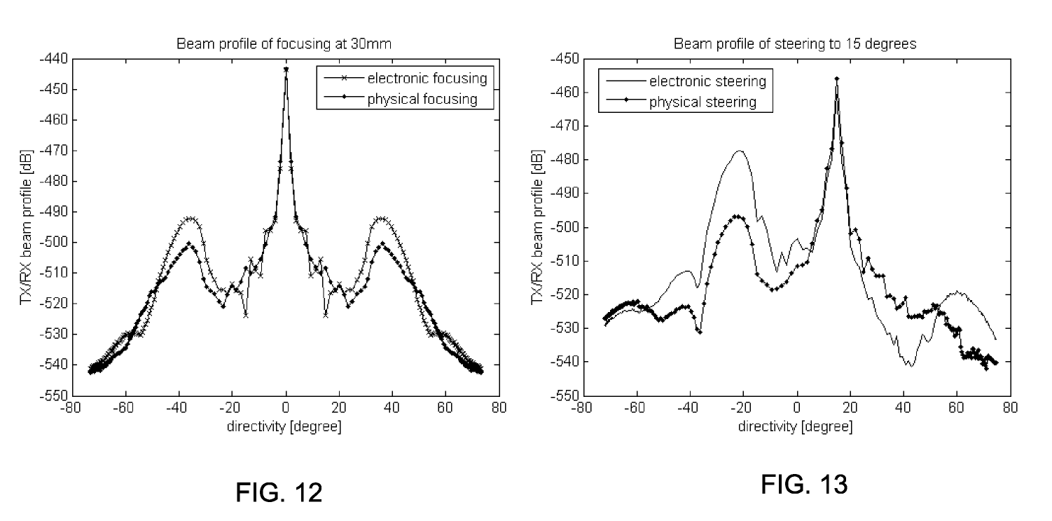

FIGS. 12 and 13 are graphs of simulated ultrasonic beam signal strength in dB versus directivity in degrees comparing signal strength simulated during electronic focusing and steering and physical focusing and steering. The simulation software used is as described in Jensen, J., Field: a program for simulating ultrasound systems, Med. Biol. Eng. Comp. 10^{th} Nordic-Baltic Conf. On Biomedical Engineering 4, Part I, 1996, pp. 351-353, the entirety of which is hereby incorporated by reference herein.

In FIGS. 12 and 13, the CMUT array 102 is linear and is composed of 64 or 128 CMUT elements 104. Each of the CMUT elements 104 is 250 μm wide (as measured along the x-axis), 2.4 mm long (as measured along the y-axis), and is spaced by 300 μm from an adjacent CMUT element 104. The central frequency of each of the CMUTs 200 of each of the elements 104 of the array 102 is 8 MHz. The CMUT parameters are similar to those used in Guldiken, R. O., Balantekin, M., Zahorian, J. an Degertekin F. L., Characterization of Dual-Electrode CMUTs: Demonstration of Improved Receive Performance and Pulse Echo Operation with Dynamic Membrane Shaping, IEEE Trans. Ultrasonics, Ferroelectrics, and Frequency Control, vol. 55, no. 10, October 2008, there entirety of which is hereby incorporated by reference herein. Each of the elements 104 of the array 102 is excited using four sinusoidal cycles, and the impulse response is set to two sinusoidal cycles at 8 MHz with a Hanning weighting to simulate CMUT properties, as described in Bavaro, V. Caliano, G., and Pappalardo, M., Element Shape Design of 2-D CMUT Arrays for Reducing Grating Lobes, IEEE Trans. Ultrasonics, Ferroelectrics, and Frequency Control, vol. 55, no. 2, February 2008, the entirety of which is hereby incorporated by reference herein.

FIG. 12 in particular shows a transmit/receive beam profile of a 32-element group sub-aperture of the CMUT array 102 with and without physical focusing. The CMUT array 102 is positioned as shown in FIG. 1, and the target 108 is placed (0,0,30 mm) away from the array 102. Two grating lobes on the side of the main lobe due to the periodic array layout are visible in FIG. 12. However, even though the main lobes obtained with both physical and electronic focusing are similar in strength, the grating lobes generated when physical focusing is used are approximately 10 dB lower than when electronic focusing is used.

In FIG. 13, the transmit/receive beam profile of a 16-element group sub-aperture of the array 102 with and without physical steering is shown. The beam is focused at a point (8,0,30) mm from the array 102, which is equivalent to steering the beam by approximately 15 degrees. Even though the main lobes obtained with both physical and electronic steering are similar in strength, the grating lobe to the left of the main lobe is approximately 20 dB lower when physical steering is used rather than electronic steering.

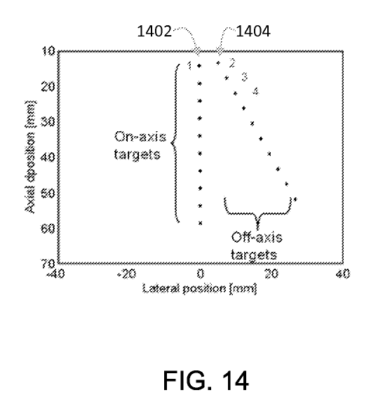

Referring now to FIG. 14, there is shown a phantom 1400 used for imaging simulations. The phantom 1400 has ten point targets (“on-axis targets”) 1402 that are aligned on the z-axis when the CMUT array 102 is located in the xy plane, as it is in FIG. 1. The phantom 1400 also has ten point targets (“off-axis targets”) 1404 that are 30 degrees off the z-axis. The same array 102 as used to generate the data shown in FIG. 12 is used to image the phantom 1400. Because the first grating lobe of the array 102 was calculated to be at 40 degrees, the grating lobes of several groups of CMUTs 200 will hit the off-axis targets 1404 while scanning the on-axis targets 1402, creating false images of the off-axis targets 1404 alongside the on-axis targets 1402. For ease of reference, one of the on-axis targets 1402 is labelled target “1”, while three of the off-axis targets 1404 are labelled targets “2”, “3”, and “4”.

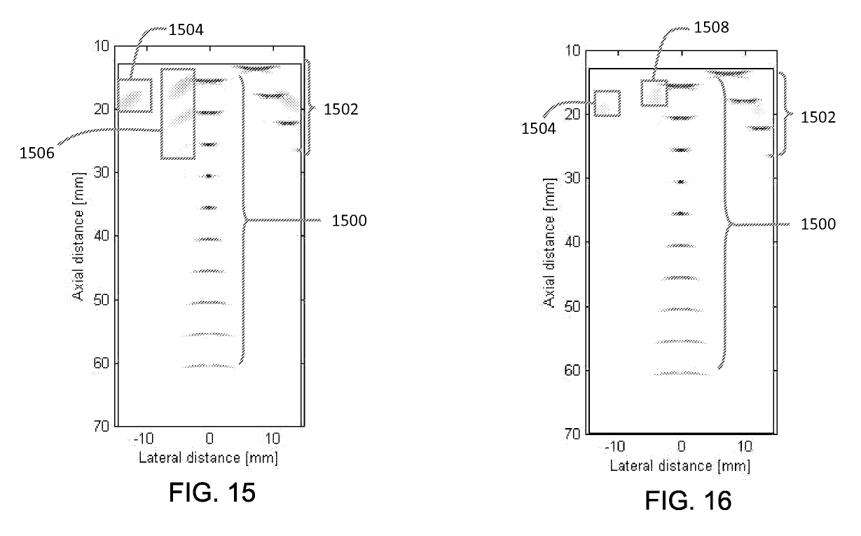

The phantom 1400 is used to create B-mode images using electronic and physical focusing. The array 102 used to image the phantom 1400 has 128 CMUT elements 104 and is otherwise configured identically as described above in respect of FIG. 12. FIGS. 15 and 16 display images of the phantom 1400 generated using electronic focusing (FIG. 15) and physical focusing (FIG. 16). Ideally, each of the on-axis targets 1402 and off-axis targets 1404 are imaged once. In FIG. 15, while correct images of the on-axis targets (“on-axis images 1500”) and off-axis targets (“off-axis images 1502”) can be seen, artefacts in the form of a false image of target 1 1504 and false images of targets 2 through 4 1506 are also visible. In FIG. 16, the correct on-axis and off-axis images 1500, 1502 are also visible, but the false image of target 1 1504 is less prominent than in FIG. 15. Furthermore, instead of false images of targets 2 through 4, only a false image of target 2 1506 is visible and it is less pronounced than the corresponding false image of target 2 shown in FIG. 15. Consequently, FIGS. 15 and 16 are evidence that physical focusing can generate images with fewer and less pronounced imaging artefacts than electronic focusing.

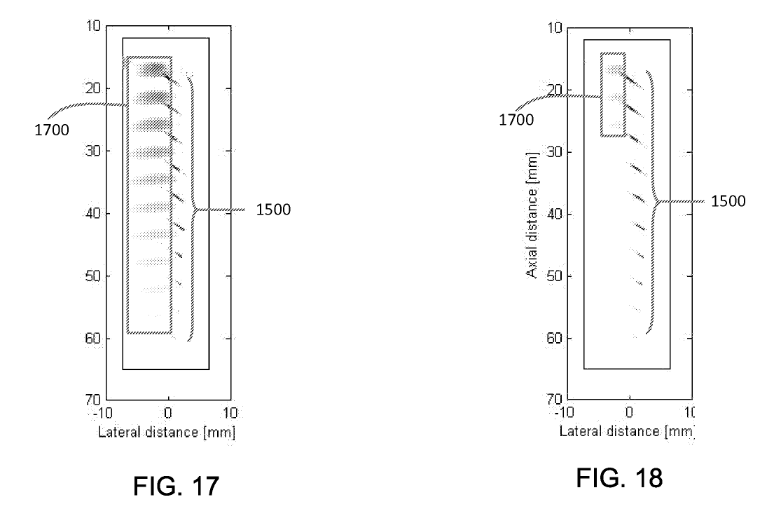

The phantom 1400 is also used to create B-mode images using electronic and physical steering performed in conjunction with electronic focusing. The CMUT array 102 used to compare electronic and physical steering is composed of 64 of the CMUT elements 104 arranged linearly from which a group of 16 of the CMUT elements 104 is excited at a time. The steering angle used is 9 degrees. FIGS. 17 and 18 display geometrically corrected images of the phantom 1400 generated using electronic steering (FIG. 17) and physical steering (FIG. 18). Ideally, only the on-axis targets 1402 are imaged. In FIG. 17, while the correct on-axis images 1500 are present, artefacts in the form of false images of all ten of the off-axis targets 1102 are also visible. In FIG. 18, the correct on-axis images 1500 are also present, but only false images of targets 2 through 4 1506 are visible, and they are less pronounced than the corresponding false images of FIG. 17. Consequently, FIGS. 16 and 17 are evidence that physical steering can generate images with fewer and less pronounced imaging artefacts than electronic steering.

### EXEMPLARY APPLICATIONS

As discussed above, a priori information can be used to better focus and steer the ultrasonic waves 106. For example, the received current signals 404 may be compared to the a priori information, and any differences between the received current signals 404 and the a priori information due to the speed of sound in the tissue containing the target 108 are estimated. As discussed above, the control signals 402 sent to the array 102 can be modified to take account for aberrations in the tissue, and the shapes of the membranes 202 of the CMUTs 200 can accordingly be modified by altering the bias voltages applied across them to complement any aberration in the tissue and to create the desired waveform. For example, if the a priori information includes information on different tissue types in the medium 109, the master controller 408 can correct for differences in ultrasonic wave speed through the different tissue types. This, in turn, allows the beamformer 406 to more accurately direct the ultrasonic waves 106 at the target 108, which can increase resolution of the target 108.

Coded excitation has been established as a practical technique for improving the quality of diagnostic ultrasound imaging. Various codes have been proposed as candidates for coded excitation. These codes can be either continuous (linear and nonlinear frequency modulation chirps) or bi-phase (Barker, orthogonal Golay, m-sequences, etc.). In another embodiment, such codes can be applied as symmetric and asymmetric modulation voltage signals.

Another exemplary use of the CMUT 200 is that when the magnitude of the received current signals 404 is less than expected, the CMUT 200 can be biased so as to increase its sensitivity, thereby increasing the magnitude of the received current signals 404. As discussed above, to increase the sensitivity of the CMUT 200 the size of the vacuum gap 206 can be decreased by uniformly increasing the magnitude of the bias voltage across the membrane 202. Analogously, if the magnitude of the received current signals 404 is greater than expected, the CMUT 200 can be biased so as to decrease its sensitivity. In these two particular examples, the a priori information can be an expected magnitude of the received current signals 404 based on similar experiments done on similar targets 108 in similar tissue. One example of applying this approach is dynamic/adaptive Time Gain Compensation (TGC) in ultrasound imaging. TGC refers to the adjustment of amplification parameters used to amplify the received current signals from increasing tissue depths, which adjustments are typically made manually by the operators. The CMUT 200 is able to adjust the gain parameters by adaptively and dynamically adjusting the bias voltage during reception based on the a priori information of the tissue depth.

As another example, the waveforms of the bias voltage and the modulation voltage applied to the CMUT 200 are determined to amplify the received echo signals through active sensing. The parameters of the waveforms can include the frequency, phase and amplitude of the modulation voltage. The frequency and phase of the received current signals 404 can be measured, and the frequency and phase of the modulation voltage applied to the CMUT 200 can be adaptively adjusted to correspond to those of the received current signals 404. Frequency may change, for example, if certain frequency components of the ultrasonic waves 106 are attenuated in the medium 109. Doing so can also improve receive sensitivity by establishing a parametric amplifier. The higher frequency components resulting from the nonlinearity of the CMUT motion are used as the pumping frequency, and the phase of the vibration of the CMUT array 102 and that of the received current signals 404 are synchronized. In this example, the a priori information is the frequency, phase and amplitude information from previously received current signals 404. This is an extension to CMUT devices of the Parametric Amplification approach employed in electrical circuits and mechanical systems, and are of increasing interest to the field of Micro-electro-mechanical-systems (MEMS).

As another example, the echo signals may be striking the membrane 202 along a path that is not parallel with the symmetrically or asymmetrically biased propagation axes of the CMUT 200. In response to the echo signals, the processing unit 400 can adaptively change the bias voltage being applied to the membrane 202 so as to change the steering angle θ such that the asymmetrically biased propagation axis of the CMUT 200 becomes parallel with the echo signals. Doing so can improve CMUT sensitivity. Various forms of digital signal processing can be performed by the master controller 408 to further contribute to sensitivity.

In an alternative embodiment, the membrane 202 may be symmetrically or asymmetrically biased, and the capacitance difference between the top and left bottom electrodes 214 and 216, and the top and right bottom electrodes 214 and 218 is used as an indicator of the Direction of Arrival (DOA) of the incoming acoustic signal. Using digital signal processing, the direction of the incoming acoustic signal can be extracted from the measurements of the signals received on the separate electrodes 214, 216, 218.

In yet another embodiment, when the CMUT cells are operating with symmetric bias and modulation voltages, they show heavily damped behavior in soft tissues or fluid-like tissues. When applying asymmetric bias or asymmetric modulation voltages, the CMUTs will have resonant peaks at frequencies in accordance with higher order vibration modes. The amplitude and frequency values of the peaks indicate the mechanical properties of the fluid medium, such as density, elasticity, and viscosity, which can be deduced from the frequency spectrum of the echo signals.

The CMUT 200 may be used to reduce acoustic crosstalk among the CMUT cells. Acoustic crosstalk is a phenomenon where the movement of one CMUT cell affects other CMUT cells. Due to acoustic crosstalk, a CMUT cell may vibrate asymmetrically, with lower velocity, or out of phase when subjected to the acoustic pressure in the medium generated by other CMUT cells, and the output pressure of the CMUT array may consequently be reduced. In this example, the a priori information is the set of echo signals when acoustic crosstalk is present, and the processing unit 400 changes the bias or AC voltage signals to do one or more of the following: asymmetrically actuate the CMUT membrane; and to adjust any one or more of the sensitivity, frequency and phase of the CMUT membrane's movement. The objectives are to compensate for the crosstalk signal and to maintain the output power level.

The CMUT 200 may also be used to facilitate harmonic imaging. The modulation and bias voltages applied across the membrane 202 may shape the membrane 202 into a particular harmonic mode. Each harmonic mode has a resonant frequency. The echo signals at the resonant frequency are received with higher sensitivity than if the membrane 202 were not shaped into the harmonic mode. In this way the CMUT 200 can be tuned to receive a range of higher frequencies (such as twice the fundamental frequency) that is useful for harmonic imaging.

The CMUT 200 may also be used to high intensity focused ultrasound (“HIFU”). Each of the CMUT elements 104 in the array 102 can be focused at the target 108, and a feedback loop can be established such that the ultrasonic beam is continuously directed at the target 108 notwithstanding movement of the array 102.

Another application of the CMUT 200 is the calibration of manufactured CMUT arrays to compensate for manufacturing defects. A CMUT array may include cells whose vibration centers are shifted, or that vibrate with a lower amplitude due to imperfections in the fabrication process. The a priori information is the membrane deflection profile or output acoustic pressure on the surface of each individual cell. The processing unit 400 finds the positions of the defected cells and applies compensation (symmetric or asymmetric) bias or AC voltage to make the movement of the cells uniform and/or to improve image quality.

### Finite Element Modeling

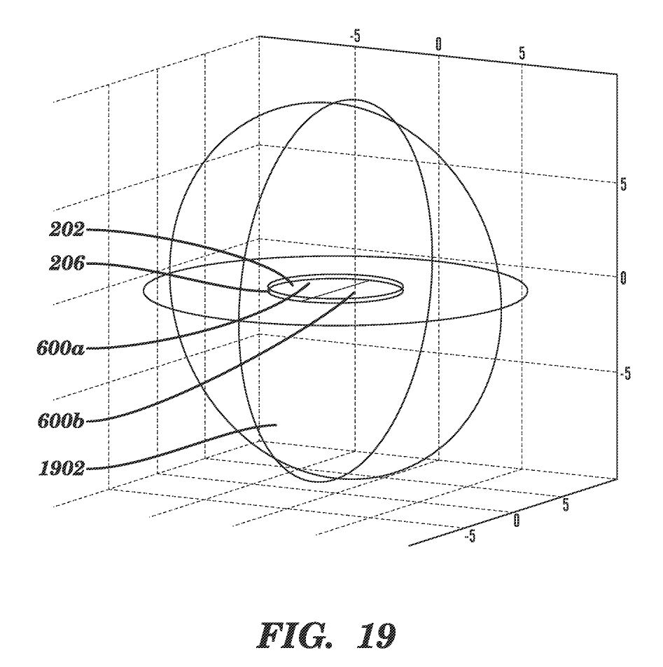

FIGS. 19 through 23 depict a finite element model of the CMUT 200, and the results generated through simulation of the modeled CMUT 200. Comsol Multiphysics™ software was used; this software facilitates building of coupled physical models, divides the modeled structure into meshed units, and solves partial differential equations involving the meshes using finite element methods.

FIG. 19 shows a finite element model of one embodiment of the CMUT 200. The modeled CMUT 200 includes the membrane 202, the vacuum gap 206, and the first and second electrode pairs 600a, b as depicted in FIG. 6(a). The modeled CMUT 200 is immersed in water 1902, into which the ultrasonic waves 106 are directed. The components of FIG. 19 are composed of three physical subdomains. One of the subdomains is a structural mechanics subdomain, which includes the modeled CMUT 200 itself, and is modeled using the membrane 202, which is circular, made of polysilicon with a radius a=35 μm and a thickness h=1.5 μm. Another of the subdomains is an electrostatics subdomain, which includes the vacuum gap 206, which has a thickness d=0.75 μm; the electrode pairs 600a, b and the water 1902. The top electrodes of the electrode pairs 600a, b are simplified as applied voltages at the bottom of the membrane 202, and the bottom electrodes are simplified as electrical ground located at the bottom of the vacuum gap 206. A third of the subdomains is a pressure acoustics subdomain, which also includes the water medium and which is spherically shaped around the CMUT 200 with a radius of 1 mm. The water is used to study how much acoustic pressure is transmitted from the CMUT 200.

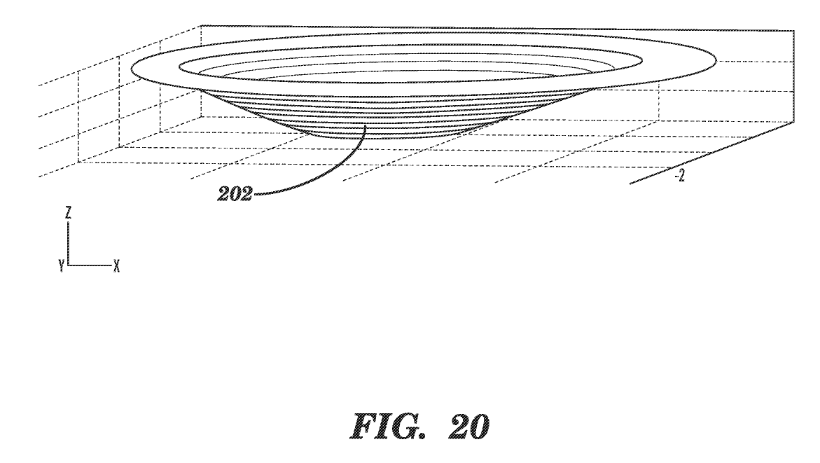

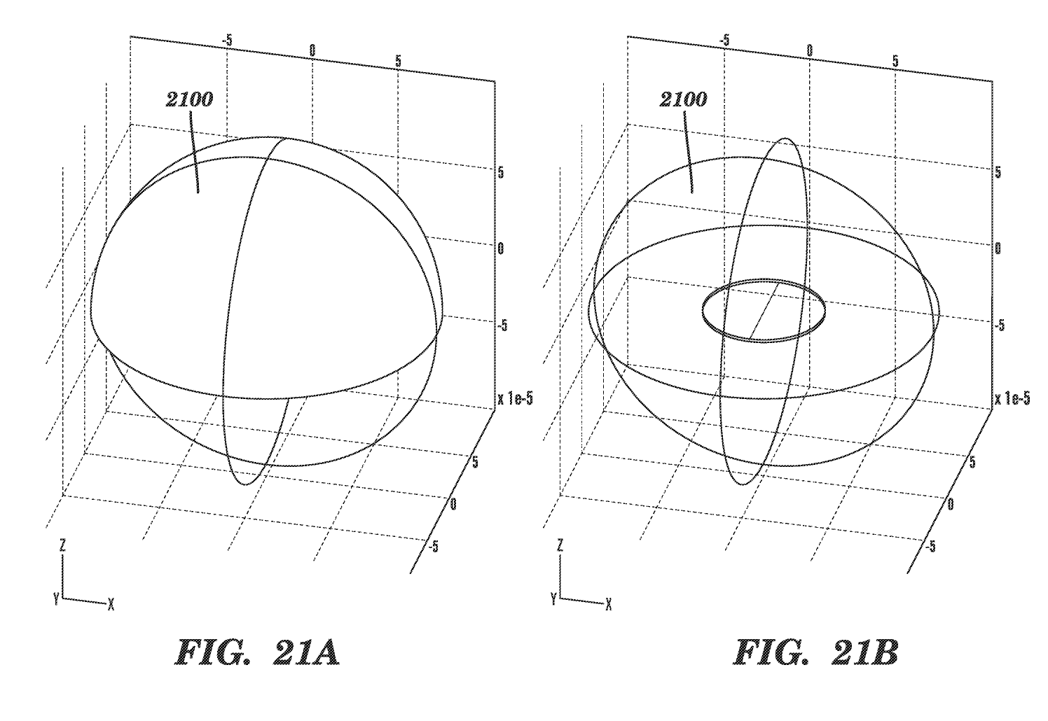

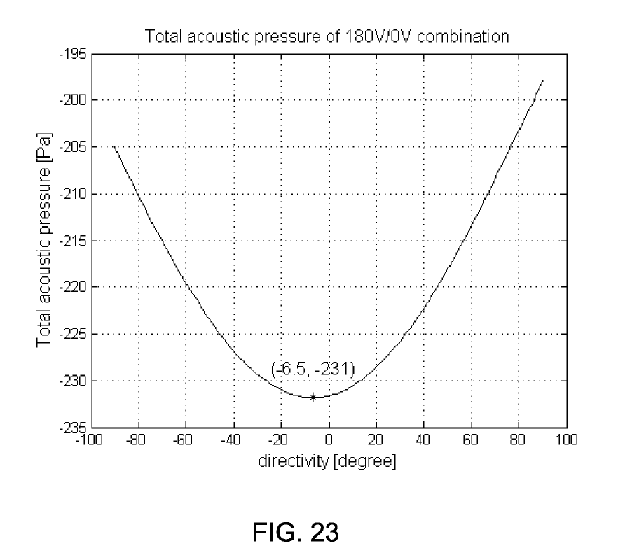

The frequency response package of the structural mechanics module and the time-harmonic package of the pressure acoustics module of the Comsol Multiphysics™ software were used to conduct a parametric frequency response analysis of the modeled CMUT 200. The analysis was performed over a range of membrane vibration frequencies (from 1 MHz to 10 MHz). The bias voltages for the top electrodes of the electrode pairs 600a, b were set to 180 V for the left top electrode and 0 V for the right top electrode. FIG. 20 is a perspective view of how the membrane 202 is shaped as a result of this bias voltage; the membrane 202 is clearly asymmetrically deformed, with the left side more deformed than the right side. FIGS. 21(a) and (b) show how a top hemisphere 2100 of the water medium along which acoustic pressure is measured and displayed in FIG. 22. In FIG. 22 there is shown a graph of total acoustic pressure on the top hemisphere 2100, which shows acoustic pressure being greater on the left side of the top hemisphere 2100 than on the right. FIG. 23 is a graph of acoustic pressure in Pa vs. directivity in degrees, and in accordance with FIGS. 21(a), 21(b) and 22, shows that acoustic pressure is maximized at about 7 degrees to the left of the centre of the top hemisphere 2100. These simulations demonstrate that asymmetric bias voltages applied across the membrane 202 of the CMUT 200 are able to steer the ultrasonic beam 106 emitted from the membrane 202 to different angles, which can be used in a number of applications to improve ultrasound imaging quality.

The foregoing embodiments of methods describing how to physically steer and focus one or more of the CMUTs 200 and various embodiments of the CMUT arrays 102 can be stored on a computer readable medium for execution by a processor. For example, the master controller 408 or any other processor may be communicatively coupled to a computer readable medium having stored thereon statements and instructions to cause the master controller 408 to execute any of the foregoing embodiments of methods. Exemplary computer readable media include disc-based media such as CD-ROMs and DVDs, magnetic media such as hard drives and other forms of magnetic disk storage, semiconductor based media such as flash media, random access memory, and read only memory.

It is contemplated that any part of any aspect or embodiment discussed in this specification can be implemented or combined with any part of any other aspect or embodiment discussed in this specification.

For the sake of convenience, the exemplary embodiments above are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

While particular example embodiments have been described in the foregoing, it is to be understood that other embodiments are possible and are intended to be included herein. It will be clear to any person skilled in the art that modifications of and adjustments to the foregoing exemplary embodiments, not shown, are possible.

What is claimed:

1. A method for shaping a membrane of a CMUT comprising applying a bias voltage asymmetrically to the membrane such that the membrane is shaped to send ultrasonic waves that propagate along an asymmetrically biased propagation axis that differs from a symmetrically biased propagation axis along which the membrane is shaped to send the ultrasonic waves when the membrane is symmetrically biased.

2. A method as claimed in claim 1 further comprising generating the ultrasonic waves that propagate along the asymmetrically biased propagation axis by applying a modulation voltage to the membrane.

3. A method as claimed in claim 2, wherein the modulation voltage is a coded excitation.

4. A method as claimed in claim 1 further comprising receiving incident ultrasonic waves that propagate along the asymmetrically biased propagation axis.

5. A method as claimed in claim 1, wherein the membrane is rotationally symmetric.

6. A method as claimed in claim 1, wherein applying the bias voltage comprises applying a plurality of voltage signals at rotationally symmetric locations on the membrane, wherein at least two of the plurality of voltage signals differ in magnitude.

7. A method as claimed in claim 1, wherein applying the bias voltage comprises applying a plurality of voltage signals at rotationally asymmetric locations on the membrane, wherein at least two of the plurality of voltage signals have identical magnitudes.

8. A method as claimed in claim 1, wherein the asymmetrically biased propagation axis and the symmetrically biased propagation axis intersect.

9. A method as claimed in claim 8, wherein the asymmetrically biased propagation axis and the symmetrically biased propagation axis intersect at a location on the membrane.

10. A method as claimed in claim 8, wherein the asymmetrically biased propagation axis and the symmetrically biased propagation axis intersect at a location offset from the membrane.

11. A method as claimed in claim 1, wherein the asymmetrically biased propagation axis and the symmetrically biased propagation axis are parallel.

12. A method as claimed in claim 1, wherein the asymmetrically biased propagation axis and the symmetrically biased propagation axis are neither parallel nor intersect.

13. A method as claimed in claim 1, wherein the symmetrically biased propagation axis is normal to a substrate of the CMUT and the asymmetrically biased propagation axis is not normal to the substrate of the CMUT.

14. A method as claimed in claim 1, wherein the bias voltage comprises an alternating current voltage signal.

15. A method as claimed in claim 14, wherein the alternating current voltage signal is applied when receiving incident ultrasonic waves.

16. A method as claimed in claim 5, wherein applying the bias voltage asymmetrically comprises:
(a) applying a first bias voltage across a first pair of electrodes such that the first bias voltage is applied across one lateral half of the membrane; and
(b) applying a second bias voltage across a second pair of electrodes such that the second bias voltage is applied across another lateral half of the membrane, wherein the first and second voltages differ in magnitude.

17. A method as claimed in claim 1, wherein the membrane is metallized such that applying the bias voltage to the membrane comprises electrically coupling the membrane to a voltage source.

18. A method as claimed in claim 1, wherein the CMUT comprises one of a plurality of CMUTs that comprise an array, and wherein each of the plurality of CMUTs is biased such that propagation axes of the plurality of CMUTs intersect a common focal point.

19. A method as claimed in claim 1, wherein the CMUT comprises one of a plurality of CMUTs that comprise an array, and wherein each of the plurality of CMUTs is asymmetrically biased such that the asymmetrically biased propagation axes of the plurality of CMUTs are parallel.

20. A method as claimed in claim 1 further comprising adaptively shaping the membrane by:
(a) obtaining a priori information prior to generating the ultrasonic waves;
(b) determining the bias voltage in accordance with the a priori information in order to improve an image obtained by analyzing an echo signal that results from reflection of the ultrasonic waves; and
(c) generating the ultrasonic waves.

21. A method as claimed in claim 2 further comprising adaptively shaping the membrane by:
(a) obtaining a priori information prior to generating the ultrasonic waves;
(b) determining the modulation voltage in accordance with the a priori information in order to improve an image obtained by analyzing an echo signal that results from reflection of the ultrasonic waves; and
(c) generating the ultrasonic waves.

22. A method as claimed in claim 2 further comprising, when the membrane is receiving incident ultrasonic waves, adaptively shaping and vibrating the membrane by:
(a) obtaining a priori information prior to receiving an echo signal that results from reflection of the ultrasonic waves, wherein the a priori information comprises one or more of frequency, phase and amplitude information current signals that are generated by previously received ultrasonic echoes;
(b) determining waveforms of the bias voltage and the modulation voltage from the a priori information;
(c) biasing the membrane using the bias voltage waveform and modulating the membrane using the modulation voltage waveform while receiving the echo signal.

23. A method as claimed in claim 20 further comprising:
(a) receiving the echo signal; and
(b) generating the image by analyzing the echo signal in accordance with the a priori information.

24. A method as claimed in claim 23, wherein the echo signal is reflected off an imaging target, and further comprising estimating mechanical properties of the imaging target by analyzing the symmetric and asymmetric parts of the echo signal.

25. A method as claimed in claim 23 further comprising estimating the direction of arrival of the ultrasonic waves by analyzing the symmetric and asymmetric parts of the echo signal.

26. A system for shaping a membrane of a CMUT, the system comprising:
(a) the CMUT; and
(b) a control system communicatively coupled to the CMUT, the control system comprising a controller and a memory communicatively coupled to the controller having encoded thereon statements and instructions to cause the control system to execute a method as claimed in claim 1.

27. A system as claimed in claim 26 wherein the control system comprises:
(a) a beamformer configured to output beamforming parameters comprising a bias voltage corresponding to a direction in which the CMUT is to transmit ultrasonic waves; and
(b) a processing unit communicatively coupled between the beamformer and the CMUT containing the controller and the memory.

28. A computer readable medium having encoded thereon statements and instructions to cause a processor to execute a method as claimed in claim 1.
